(19) United States
(12) Patent Application Publication
(10) Pub. No.: US 2023/0080630 A1
(43) Pub. Date: Mar. 16, 2023

(54) TRAVELING LANE PLANNING DEVICE, STORAGE MEDIUM STORING COMPUTER PROGRAM FOR TRAVELING LANE PLANNING, AND TRAVELING LANE PLANNING METHOD

(71) Applicant: TOYOTA JIDOSHA KABUSHIKI KAISHA, Toyota-shi (JP)

(72) Inventors: Takahiro SETA, Yokohama-shi (JP); Ryuta HASHIMOTO, Tokyo-to (JP); Takahiro KAWANO, Tokyo-to (JP); Kota HARADA, Tokyo-to (JP); Yuki MORI, Tokyo-to (JP)

(73) Assignee: TOYOTA JIDOSHA KABUSHIKI KAISHA, Toyota-shi (JP)

(21) Appl. No.: 17/868,335

(22) Filed: Jul. 19, 2022

(30) Foreign Application Priority Data
Sep. 16, 2021 (JP) 2021-151293

(51) Int. Cl. G06V 20/56; B60W 40/09

(52) U.S. Cl. CPC G06V 20/588; B60W 40/09; B60W 2554/4045; B60W 2554/4041; B60W 2420/42; B60W 2552/53; B60W 2552/10; B60W 2554/4046

(57) ABSTRACT

A traveling lane planning device has a processor configured to determine whether or not a branching terrain exists that has a first lane and a second lane adjacent to the first lane wherein the first lane branches into a third lane and a fourth lane at a branching start location in the traveling direction of the vehicle within a driving zone, when the branching terrain exists and the vehicle is located before the branching start location, to acquire lane movement information for movement between the first lane and second lane came off in the past, and based on the lane movement information, to select one lane from among the third lane and fourth lane as the lane to be taken at the branching start location and generate a traveling lane plan that indicates a scheduled traveling lane for traveling of the vehicle in the driving zone.

### FIELD

The present disclosure relates to a traveling lane planning device, to a storage medium storing a computer program for traveling lane planning, and to a traveling lane planning method.

### BACKGROUND

An automatic control system installed in a vehicle creates a navigation route for the vehicle based on the current location of the vehicle, the destination location of the vehicle, and a navigation map. The automatic control system estimates the current location of the vehicle using the map information and selects the traveling lane in which the vehicle is to travel so that it travels along the navigation route, thereby generating a traveling lane plan.

Depending on the location where the vehicle is traveling, the traveling lane may have a branching terrain branching into two lanes at a branching start location. When at the branching start location, the vehicle can proceed in either of the two lanes diverging from the branching start location.

In this case, it is proposed that the automatic control system evaluates multiple possible traffic lanes and proposes selection of a traffic lane for the vehicle to proceed on (see Japanese Unexamined Patent Publication No. 2016-224802, for example).

### SUMMARY

When a road in which a vehicle is traveling has at least two lanes, (a first traffic lane and a second traffic lane on the passing lane side), the vehicle sometimes moves between lanes in response to a driver request, before reaching the branching start location. Previous movement between lanes by the driver is assumed to reflect the intention of the driver in regard to future lane selection.

It is therefore an object of the present disclosure to provide a traveling lane planning device that can select a traffic lane that is assumed to reflect the intention of the driver when the vehicle is in a branching terrain.

One embodiment of the invention provides a traveling lane planning device. The traveling lane planning device has a branching assessment unit that determines whether or not a branching terrain exists that has a first lane and a second lane adjacent to the first lane wherein the first lane branches into a third lane and a fourth lane at a branching start location in the traveling direction of the vehicle within a predetermined driving zone from the current location of a vehicle, an information acquisition unit that acquires lane movement information for movement between the first lane and second lane came off in the past when the branching terrain exists within the driving zone and the vehicle is located before the branching start location and a traveling lane planning unit that selects one lane from among the third lane and fourth lane as the lane to be taken at the branching start location based on the lane movement information and generates a traveling lane plan that indicates a scheduled traveling lane for traveling of the vehicle in the driving zone.

In the traveling lane planning device, it is preferable that the traveling lane planning unit selects the one lane located on the opposite side from the direction in which the vehicle has attempted to move between the first lane and second lane as the lane to be taken at the branching start location, based on the lane movement information, when the first lane, the second lane, the third lane and the fourth lane are within the same road.

In the traveling lane planning device, it is preferable that the traveling lane planning unit selects the one lane located on the same side as the direction in which the vehicle has attempted to move between the first lane and second lane as the lane to be taken at the branching start location, based on the lane movement information, when the third lane and the fourth lane are within different roads.

According to another embodiment, a non-transitory storage medium storing a computer program for traveling lane planning is provided. The computer program for traveling lane planning causes a processor execute a process and the process includes determining whether or not a branching terrain exists that has a first lane and a second lane adjacent to the first lane wherein the first lane branches into a third lane and a fourth lane at a branching start location in the traveling direction of the vehicle within a predetermined driving zone from the current location of a vehicle, acquiring lane movement information for movement between the first lane and second lane came off in the past when the branching terrain exists within the driving zone and the vehicle is located before the branching start location, and selecting one lane from among the third lane and fourth lane as the lane to be taken at the branching start location based on the lane movement information and generating a traveling lane plan that indicates a scheduled traveling lane for traveling of the vehicle in the driving zone.

Another embodiment of the invention provides a traveling lane planning method. The traveling lane planning method is carried out by a traveling lane planning device and the method includes determining whether or not a branching terrain exists that has a first lane and a second lane adjacent to the first lane wherein the first lane branches into a third lane and a fourth lane at a branching start location in the traveling direction of the vehicle within a predetermined driving zone from the current location of a vehicle, acquiring lane movement information for movement between the first lane and second lane came off in the past when the branching terrain exists within the driving zone and the vehicle is located before the branching start location, and selecting one lane from among the third lane and fourth lane as the lane to be taken at the branching start location based on the lane movement information and generating a traveling lane plan that indicates a scheduled traveling lane for traveling of the vehicle in the driving zone.

The traveling lane planning device of the present disclosure utilizes information for previous movement between lanes by the driver, and thus allows selection of a traffic lane that is assumed to reflect the intention of the driver when the vehicle is in a branching terrain.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating operation of the traveling lane planning device of the embodiment in overview.

FIG. 2 is a general schematic drawing of a vehicle in which a vehicle control system is installed that has a traveling lane planning device of the embodiment.

FIG. 3 is an example of an operation flow chart for traveling lane plan processing by a traveling lane planning device of the embodiment.

FIG. 4 is a diagram illustrating an example of traveling lane plan processing (1).

FIG. 5 is a diagram illustrating an example of traveling lane plan processing (2).

FIG. 6 is a diagram illustrating an example of traveling lane plan processing (3).

### DESCRIPTION OF EMBODIMENTS

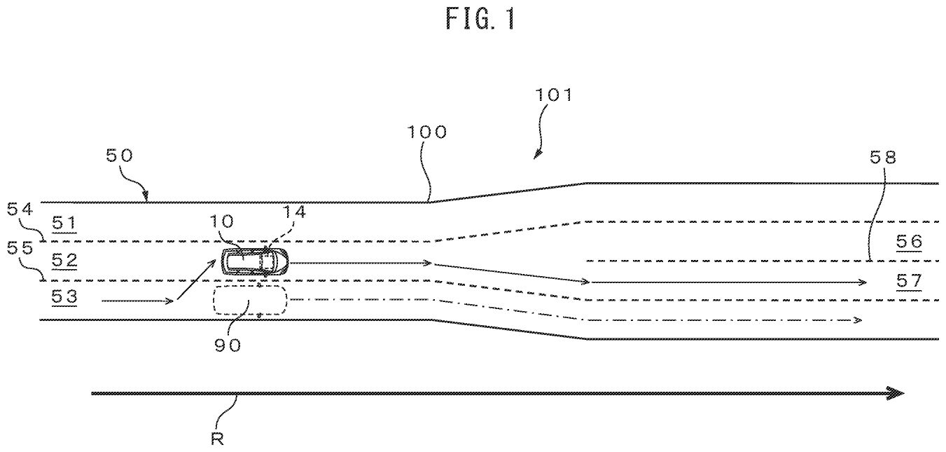

FIG. 1 is a diagram illustrating operation of the traveling lane planning device 14 of the embodiment. Operation relating to traveling lane plan processing by the traveling lane planning device 14 disclosed herein will now be described in overview with reference to FIG. 1.

The vehicle 10 is traveling on a traffic lane 52 of a road 50 having traffic lanes 51, 52, 53. The lane 51 and lane 52 are divided by a lane marking line 54, and the lane 52 and lane 53 are divided by a lane marking line 55.

The traffic lane 52 in which the vehicle 10 is traveling branches into a lane 56 and lane 57 at a branching start location 100, and extends in the traveling direction of the vehicle 10. The lane 56 and lane 57 are part of the same road 50. The lane 56 and lane 57 are divided by a lane marking line 58. The region between the end point of the lane 52 and the start point of lane 56 and lane 57 is a zone without a lane marking line.

The navigation route R of the vehicle 10 indicates forward progression of the road 50, including the branching start location 100.

The terrain that includes the branching start location 100 is a branching terrain 101. At the branching terrain 101, the traffic lane 52 in which the vehicle 10 is traveling branches into the lane 56 and lane 57 at the branching start location 100 and extends in the traveling direction of the vehicle 10, while in the zone before the branching start location 100, the lane 52 is adjacent to lanes 51, 53 where the vehicle 10 can move between lanes.

The vehicle 10 is located before the branching start location 100. The traveling lane planning device 14 refers to the map information and determines that a branching terrain 101 exists within the nearest driving zone from the current location of the vehicle 10 on the navigation route R.

The traveling lane planning device 14 acquires lane movement information for movement between lane 52 and lanes 51, 53 came off in the past. The lane movement information consists of information relating to movement of the vehicle 10 between lanes from a location at a predetermined distance before the branching start location to the current location of the vehicle 10, or during a past time of a predetermined time period from the expected arrival time at which the vehicle 10 is expected to arrive at the branching start location.

In the example shown in FIG. 1, the traveling lane planning device 14 has lane movement information for movement of the vehicle 10 from the lane 53 to the lane 52. This is because the driver of the vehicle 10 has attempted to overtake a vehicle 90 ahead.

Based on the lane movement information, the traveling lane planning device 14 selects one lane from among the lane 56 and lane 57 as the lane in which to proceed at the branching start location 100. In the example shown in FIG. 1, since the lane 52, lane 53, lane 56 and lane 57 are all on the same road 50, and the vehicle 10 has moved from the lane 53 to the lane 52, the traveling lane planning device 14 selects the lane 57 that is located on the opposite side from the direction in which it has been attempted to move between the lane 52 and lane 53, as the lane in which to proceed at the branching start location 100.

The traveling lane planning device 14 also generates a traveling lane plan indicating the scheduled traveling lane in which the vehicle 10 is to travel at the nearest driving zone, so as to include the lane 57.

Although the driver of the vehicle 10 had originally intended to travel on the lane 53, movement was made to the lane 52 in order to overtake the vehicle 90 ahead. If the vehicle 10 proceeds to the lane 56, the vehicle 10 will be traveling on the lane 56 which is two lanes to the left of the lane 53 on which the driver had intended to travel. The traveling lane planning device 14 therefore selects lane 57 which is assumed to reflect the intention of the driver in the branching terrain 101, based on the lane movement information.

The driver of the vehicle 10 can thereby experience driving with a higher level of satisfaction since the vehicle 10 travels on a lane coinciding with the driver's own intention.

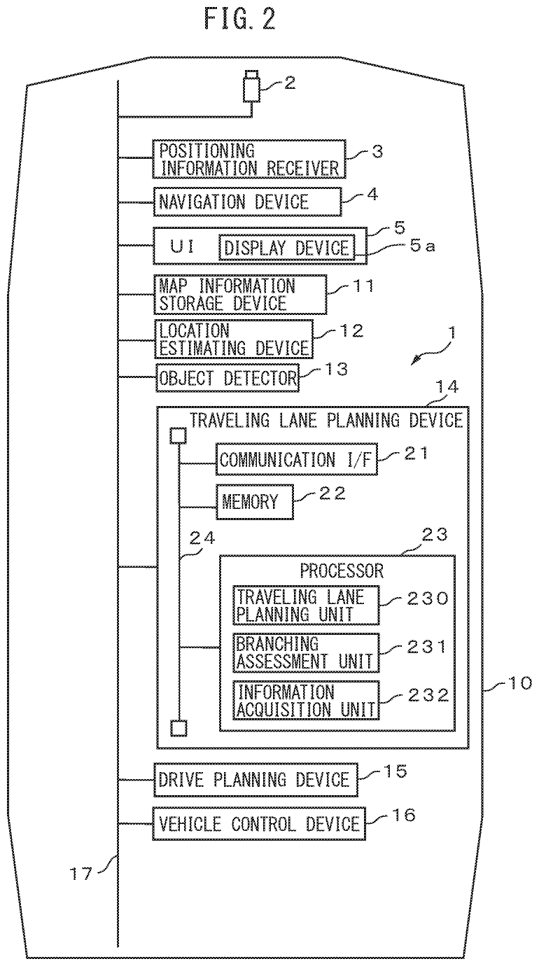

FIG. 2 is a general schematic drawing of a vehicle in which a vehicle control system 1 is installed that has a traveling lane planning device 14 of the embodiment. The vehicle 10 has a camera 2, a positioning information receiver 3, a navigation device 4, a user interface (UI) 5, a map information storage device 11, a location estimating device 12, an object detector 13, a traveling lane planning device 14, a drive planning device 15 and a vehicle control device 16, etc. The vehicle 10 may also have a LiDAR sensor, as a distance sensor (not shown) for measurement of the distance of the vehicle 10 to surrounding objects.

The camera 2, positioning information receiver 3, navigation device 4, UI 5, map information storage device 11, location estimating device 12, object detector 13, traveling lane planning device 14, drive planning device 15 and vehicle control device 16 are connected in a communicable manner through an in-vehicle network 17 that conforms to controller area network standards.

The camera 2 is an example of an imaging unit provided in the vehicle 10. The camera 2 is mounted inside the vehicle 10 and directed toward the front of the vehicle 10. The camera 2, for example, takes a camera image in which the environment of a predetermined region ahead of the vehicle 10 is shown, at a predetermined cycle. The camera image can show the road in the predetermined region ahead of the vehicle 10, and road features such as surface lane marking lines on the road. The camera 2 has a 2D detector composed of an array of photoelectric conversion elements with visible light sensitivity, such as a CCD or C-MOS, and an imaging optical system that forms an image of the photographed region on the 2D detector.

Each time a camera image is taken, the camera 2 outputs the camera image and the camera image photograph time at which the camera image was taken, through the in-vehicle network 17 to the location estimating device 12 and object detector 13 etc. The camera image is used for processing at the location estimating device 12 to estimate the location of the vehicle 10. At the object detector 13, the camera image is also used for processing to detect other objects surrounding the vehicle 10.

The positioning information receiver 3 outputs positioning information that represents the current location of the vehicle 10. The positioning information receiver 3 may be a GNSS receiver, for example. The positioning information receiver 3 outputs positioning information and the positioning information acquisition time at which the positioning information has been acquired, to the navigation device 4 and map information storage device 11 etc, each time positioning information is acquired at a predetermined receiving cycle.

Based on the navigation map information, the destination location of the vehicle 10 input through the UI 5, and positioning information representing the current location of the vehicle 10 input from the positioning information receiver 3, the navigation device 4 creates a navigation route R from the current location to the destination location of the vehicle 10, in response to a request by the driver. The navigation route R includes information relating to the locations of right turns, left turns, merging and branching. When the destination location has been newly set or the current location of the vehicle 10 has exited the navigation route R, the navigation device 4 creates a new navigation route R for the vehicle 10. Every time a navigation route R is created, the navigation device 4 outputs the navigation route R to the location estimating device 12 and the traveling lane planning device 14 etc, via the in-vehicle network 17.

The UI 5 is an example of the notification unit. The UI 5, controlled by the navigation device 4 and vehicle control device 16 etc, notifies the driver of the vehicle 10 traveling information or a lane change permission request. The traveling information of the vehicle 10 includes information relating to the current location of the vehicle and the current and future route of the vehicle, such as the navigation route. The lane change permission request is a request for the driver's permission for the vehicle 10 to move between lanes. The UI 5 also creates an operation signal in response to operation of the vehicle 10 by the driver. The UI 5 has a display device 5a such as a liquid crystal display or touch panel, for display of the traveling information. The UI 5 may also have an acoustic output device (not shown) to notify the driver of traveling information. The UI 5 also has a touch panel or operating button, for example, as an input device for inputting operation information from the driver to the vehicle 10. The operation information may be, for example, a destination location, transit points, vehicle speed or other vehicle 10 control information etc. The UI 5 outputs the input operation information to the navigation device 4 and the vehicle control device 16 etc, via the in-vehicle network 17.

The map information storage device 11 stores wide-area map information for a relatively wide area (an area of 10 to 30 km², for example) that includes the current location of the vehicle 10. The map information preferably has high precision map information including three-dimensional information for the road surface, information for the types and locations of structures and road features such as road lane marking lines, and the legal speed limit for the road. The map information storage device 11 receives the wide-area map information from an external server via a base station, by wireless communication through a wireless communication device (not shown) mounted in the vehicle 10, in relation to the current location of the vehicle 10, and stores it in the storage device. Each time positioning information is input from the positioning information receiver 3, the map information storage device 11 refers to the stored wide-area map information and outputs map information for a relatively narrow area including the current location represented by the positioning information (for example, an area of 100 m² to 10 km²), through the in-vehicle network 17 to the location estimating device 12, object detector 13, traveling lane planning device 14, drive planning device 15 and vehicle control device 16 etc.

The location estimating device 12 estimates the location of the vehicle 10 at the camera image photograph time, based on the road features surrounding the vehicle 10 represented in the camera image. For example, the location estimating device 12 compares lane marking lines identified in the camera image with lane marking lines represented in the map information input from the map information storage device 11, and determines the estimated location and estimated declination of the vehicle 10 at the camera image photograph time. The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image photograph time, the location estimating device 12 outputs this information to the object detector 13, traveling lane planning device 14, drive planning device 15 and vehicle control device 16 etc.

The object detector 13 detects other objects around the vehicle 10 and their types (for example, vehicles) based on the camera image etc, for example. Other objects also include other vehicles traveling around the vehicle 10. The object detector 13 tracks other detected objects and determines the trajectories of the other objects. In addition, the object detector 13 identifies the traveling lanes in which the other objects are traveling, based on the lane marking lines represented in the map information and the locations of the objects. The object detector 13 outputs object detection information which includes information representing the types of other objects that were detected, information indicating their locations, and also information indicating their traveling lanes, to the traveling lane planning device 14 and drive planning device 15 etc.

The traveling lane planning device 14 carries out traveling lane plan processing, branch assessment processing and information acquisition processing. The traveling lane planning device 14 comprises a communication interface (IF) 21, a memory 22 and a processor 23 for this purpose. The communication interface 21, memory 22 and processor 23 are connected via signal wires 24. The communication interface 21 has an interface circuit to connect the traveling lane planning device 14 with the in-vehicle network 17.

All or some of the functions of the traveling lane planning device 14 are functional modules driven by a computer program operating on the processor 23, for example. The processor 23 has a traveling lane planning unit 230, a branching assessment unit 231 and an information acquisition unit 232. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphic processing unit. The memory 22 is an example of a memory unit, and it has a volatile semiconductor memory and a non-volatile semiconductor memory, for example. The memory 22 stores an application computer program and various data to be used for information processing carried out by the processor 23 of each device.

At a traveling lane-planning creation time set in a predetermined cycle, the traveling lane planning unit 230 selects a traffic lane on the road on which the vehicle 10 is traveling, within the nearest driving zone (for example, 10 km) selected from the navigation route R, based on the map information, the navigation route R and surrounding environment information and the current location of the vehicle 10, and creates a traveling lane plan representing the scheduled traveling lane for traveling of the vehicle 10. For example, the traveling lane planning unit 230 creates a traveling lane plan for the vehicle 10 to travel on a traffic lane other than a passing lane. Each time a traveling lane plan is created, the traveling lane planning unit 230 outputs the traveling lane plan to the drive planning device 15.

The traveling lane planning unit 230 also determines whether or not a lane change is necessary within the nearest driving zone selected from the navigation route R, based on the traveling lane plan, the map information, the navigation route R and the current location of the vehicle 10, and generates a lane change plan in accordance with the assessment results. Specifically, the traveling lane planning unit 230 determines whether or not a lane change is necessary for moving to a traffic lane toward the destination location of the vehicle 10, based on the navigation route R and the current location of the vehicle 10. It is determined whether or not the vehicle 10 is approaching another road that merges ahead from the traveling road on which it is currently traveling (merge), or the vehicle 10 is exiting onto another road branching out ahead from the traveling road (branch). Since merging and branching involve movement of the vehicle from a lane of the traveling road to a lane in another road, a lane change is carried out. The traveling lane planning unit 230 may further utilize surrounding environment information or vehicle status information to determine whether or not a lane change is necessary. The surrounding environment information includes the locations and speeds of other vehicles traveling around the vehicle 10. The vehicle status information includes the current location of the vehicle 10, and the vehicle speed, acceleration and traveling direction. The traveling lane planning unit 230 also generates a lane change plan in response to a driver request. The driver operates a direction indicator lever (not shown), for example, making a request for a lane change to the vehicle control system 1. When a lane change plan has been generated, the traveling lane planning unit 230 outputs the traveling lane plan with the added lane change plan to the drive planning device 15. When a navigation route has not been generated, the traveling lane planning unit 230 also determines whether or not a lane change is necessary within the nearest driving zone, based on the traveling lane plan, the map information and the current location of the vehicle 10, and generates a lane change plan in accordance with the assessment results.

At a driving plan creation time set with a predetermined cycle, the drive planning device 15 carries out driving plan processing in which it creates a driving plan representing the scheduled traveling trajectory of the vehicle 10 up until a predetermined time (for example, 5 seconds), based on the traveling lane plan, the map information, the current location of the vehicle 10, the surrounding environment information and the vehicle status information. The driving plan is represented as a combination of the target location of the vehicle 10 and the target vehicle speed at the target location, at each time from the current time until the predetermined time. The cycle in which the driving plan is created is preferably shorter than the cycle in which the traveling lane plan is created. The drive planning device 15 generates a driving plan to maintain a spacing of at least a predetermined distance between the vehicle 10 and other vehicles. When the traveling lane plan includes a lane change wherein the vehicle 10 is to move between lanes, but a spacing of at least a predetermined distance cannot be ensured between the vehicle 10 and another vehicle, the drive planning device 15 generates a driving plan for stopping the vehicle 10. The drive planning device 15 outputs the driving plan to the vehicle control device 16 for each driving plan generated.

When a driving plan including a lane change has been created, the drive planning device 15 generates lane movement information that includes the two lanes between which movement of the vehicle 10 is planned and the direction in which the vehicle is to travel, as well as the time the driving plan including the lane change was generated and the location of the vehicle 10 etc, and stores this information in the memory 22. Since the lane movement information is generated when an attempt to move between lanes has been made, it is also generated when movement between lanes could not be executed.

The vehicle control device 16 controls each unit of the vehicle 10 based on the current location of the vehicle 10 and the vehicle speed and yaw rate, as well as on the driving plan generated by the drive planning device 15. For example, the vehicle control device 16 determines the steering angle, acceleration and angular acceleration of the vehicle 10 according to the driving plan and the speed and yaw rate of the vehicle 10, and sets the amount of steering, and the accelerator or brake level so as to match that steering angle, accelerator level and angular acceleration. The vehicle control device 16 also outputs a control signal corresponding to a set steering amount, to an actuator (not shown) that controls the steering wheel for the vehicle 10, via the in-vehicle network 17. The vehicle control device 16 also determines the amount of fuel injection according to a set accelerator level, and outputs a control signal corresponding to the amount of fuel injection to a drive unit (not shown) of the engine of the vehicle 10, via the in-vehicle network 17. Alternatively, the vehicle control device 16 may output a control signal corresponding to a set brake level to the brake (not shown) of the vehicle 10, via the in-vehicle network 17.

For FIG. 2, the map information storage device 11, location estimating device 12, object detector 13, traveling lane planning device 14, drive planning device 15 and vehicle control device 16 were explained as separate devices (ECUs, for example), but all or some of them may be constructed in a single device.

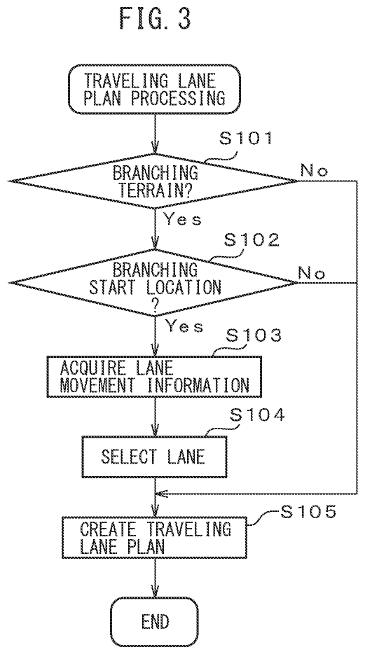

FIG. 3 is an example of an operation flow chart for traveling lane plan processing by a traveling lane planning device 14 of the embodiment. Traveling lane plan processing by the traveling lane planning device 14 will be described with reference to FIG. 3. The traveling lane planning device 14 carries out traveling lane plan processing according to the operation flow chart shown in FIG. 3, at a traveling lane-planning creation time having a predetermined cycle.

The traveling lane plan processing shown in FIG. 3 can be applied both when a navigation route R has been generated and when a navigation route R has not been generated. In either case, the prior intent of the driver to make a lane change can be respected when selecting the lane at the branching start location.

First, the branching assessment unit 231 refers to the map information and determines whether or not a branching terrain exists in a predetermined (nearest) driving zone from the current location of the vehicle 10, which includes the traveling lane on which the vehicle 10 is traveling (corresponding to the first lane) and the adjacent lane adjacent to the traveling lane (corresponding to the second lane), and wherein the traveling lane branches into two lanes (corresponding to the third lane and fourth lane) at the branching start location in a manner extending toward the traveling direction of the vehicle 10 (step S101). That a lane extends toward the traveling direction of the vehicle 10 means that the angle formed between the lane and the direction in which the traveling lane extends is 90° or smaller, for example. It is determined that no branching terrain exists if there is no adjacent lane adjacent to the traveling lane in which the vehicle 10 is traveling in a predetermined zone before the branching start location. The predetermined zone before the branching start location may be a zone between the branching start location and a location at a predetermined distance (such as 2 km) before the branching start location.

When a branching terrain exists (step S101—Yes), the branching assessment unit 231 determines whether or not the vehicle 10 is located before the branching start location (step S102). The location before the branching start location may be a zone between the branching start location and a location at a predetermined distance (such as 300 m) before the branching start location. The cycle for the traveling lane-planning creation time is preferably set so that at least one traveling lane-planning creation time is included during the period while the vehicle 10 passes between the location before the branching start location and the branching start location.

When the vehicle 10 is located before the branching start location (step S102—Yes), the information acquisition unit 232 acquires lane movement information for movement between the traveling lane and the adjacent lane came off in the past, from the memory 22 (step S103). The information acquisition unit 232 acquires lane movement information for the vehicle 10 between lanes from a location at a predetermined distance (such as 2 km) before the branching start location to the current location of the vehicle 10, or during a past predetermined time period (such as 10 seconds to 5 minutes) from the expected arrival time at which the vehicle 10 is expected to arrive at the branching start location. Previous lane changes contained in the lane movement information include lane changes executed based on driver requests and lane changes planned by the vehicle control system 1.

Based on the lane movement information, the traveling lane planning unit 230 then selects one lane from among the two lanes as the lane to be taken at the branching start location (step S104). From the viewpoint of selecting the lane at the branching start location while respecting previous intent of the driver to make a lane change, the traveling lane planning unit 230 may select one of the two lanes in the following manner. For example, when a navigation route exists, the traveling lane planning unit 230 preferably selects the lane based on the direction in which the vehicle 10 attempted to move between the traveling lane and the adjacent lane at a more recent past point than when a navigation route does not exist. This is because if a lane change is carried out regardless of the navigation route, this indicates a strong intent of the driver to make the lane change. When the speed of the vehicle 10 is below a reference speed (such as during traffic congestion, for example), the traveling lane planning unit 230 preferably selects the lane based on the direction in which the vehicle 10 has attempted to move between the traveling lane and the adjacent lane at a less recent past than when the speed of the vehicle 10 is traveling faster than the reference speed. While it is possible that a lane change may be made in response to surrounding conditions during traffic congestion, it is highly probable that such a lane change will not have been decided based on the route from the current location of the vehicle to the destination location. Furthermore, the information acquisition unit 232 may calculate a direction score based on the direction moved between lanes during previous lane changes, and the traveling lane planning unit 230 may select a lane based on a high direction score at the branching start location. The score is preferably calculated so as to strongly reflect the direction of the lane change near to the branching start location in terms of time or distance. The method of calculating the score will be described in detail below.

When the vehicle 10 has not attempted to change lanes in the predetermined zone before the branching start location, there may be no lane change information. In this case, the traveling lane planning unit 230 may select the lane among the two lanes that is not the passing lane. When a navigation route R exists, the traveling lane planning unit 230 may select a lane that requires a lower number of lane changes to be scheduled from the current location of the vehicle 10 to the destination location. When a navigation route R exists, the traveling lane planning unit 230 may select a lane included in the road represented by the navigation route R.

The traveling lane planning unit 230 then generates a traveling lane plan indicating the scheduled traveling lane in which the vehicle 10 is to travel at the nearest driving zone (step S105), and the series of process steps is complete.

When a branching terrain does not exist (step S101—No), or when the vehicle 10 is not located before a branching start location (step S102—No), processing proceeds to step S105.

In some cases the traveling lane plan processing described above may be executed multiple times for the same branching terrain. In such cases, step S103 and step S104 may be skipped from the second time onward.

A first operating example of the traveling lane planning device 14 will now be further explained with reference to FIG. 1.

In the first operating example shown in FIG. 1, the vehicle 10 is traveling on a traffic lane 52 of a road 50. In the example shown in FIG. 1, the traveling lane planning device 14 has lane movement information for attempted movement of the vehicle 10 from the lane 53 to the lane 52. This is because the driver of the vehicle 10 has attempted to overtake a vehicle 90 ahead. The lane movement information may also be information with which the traveling lane planning device 14 has planned to overtake a vehicle 90 ahead. This is because even when the traveling lane planning device 14 has planned a lane change, since the lane movement information includes the previous intent of the driver to make the lane change, the lane change is carried out after obtaining acknowledgement by the driver.

The lane 52, lane 53, lane 56 and lane 57 are within the same road 50, and the vehicle 10 has moved from the lane 53 to the lane 52. Based on the lane movement information, the traveling lane planning device 14 selects the lane 57 located on the opposite side from the direction in which the vehicle 10 has attempted to move between lane 52 and lane 53, from among lane 56 and lane 57, as the lane in which to proceed at the branching start location 100.

The traveling lane planning device 14 also generates a traveling lane plan indicating the scheduled traveling lane in which the vehicle 10 is to travel at the nearest driving zone, so as to include the lane 57.

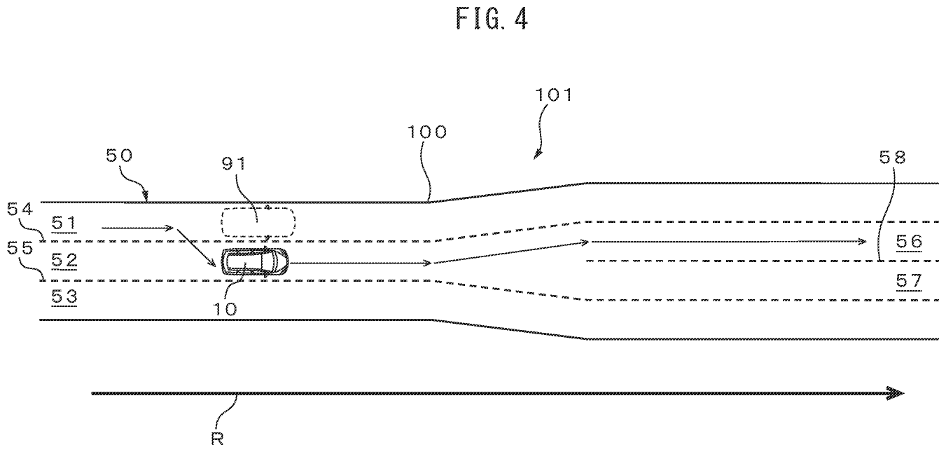

A second operating example of the traveling lane planning device 14 will now be further explained with reference to FIG. 4.

In the second operating example shown in FIG. 4, the vehicle 10 is traveling on a traffic lane 52 of a road 50, similar to the first operating example. In the example shown in FIG. 4, the traveling lane planning device 14 has lane movement information for attempted movement of the vehicle 10 from the lane 51 to the lane 52. This is because the driver of the vehicle 10 has attempted to overtake a vehicle 91 ahead. The lane movement information may also be information with which the traveling lane planning device 14 has planned to overtake a vehicle 90 ahead.

In the example shown in FIG. 4, the lane 52, lane 53, lane 56 and lane 57 are within the same road 50, and the vehicle 10 has moved from the lane 51 to the lane 52. Based on the lane movement information, the traveling lane planning device 14 selects the lane 56 located on the opposite side from the direction in which it has been attempted to move between lane 52 and lane 51, from among lane 56 and lane 57, as the lane in which to proceed at the branching start location 100.

Although the driver of the vehicle 10 had originally intended to travel on the lane 51, movement was made to the lane 52 in order to overtake the vehicle 91 ahead. If the vehicle 10 proceeded to the lane 57, then the vehicle 10 will have traveled on the lane 57 which is two lanes to the right of the lane 51 on which the driver had intended to travel. For the branching terrain 101, the traveling lane planning device 14 therefore selects lane 56 which is in line with the intention of the driver, based on the lane movement information.

The traveling lane planning device 14 also generates a traveling lane plan indicating the scheduled traveling lane in which the vehicle 10 is to travel at the nearest driving zone, so as to include the lane 56.

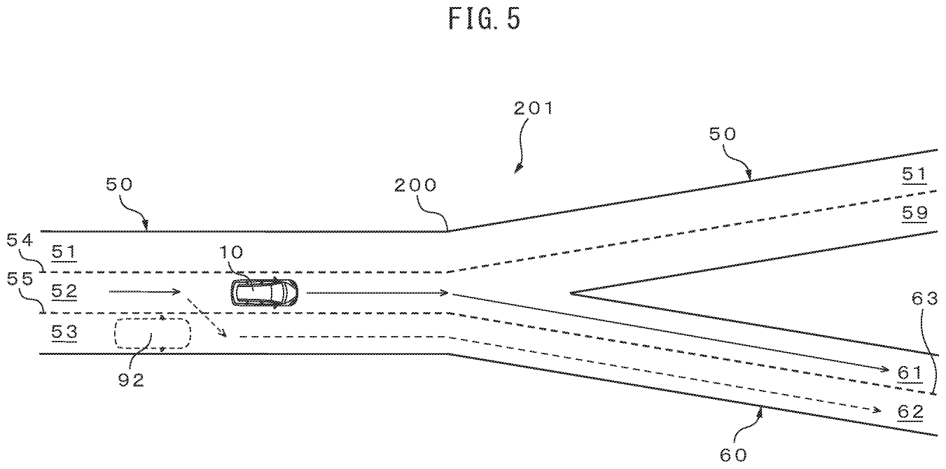

A third operating example of the traveling lane planning device 14 will now be further explained with reference to FIG. 5. No navigation route is generated for the third operating example.

The vehicle 10 is traveling on one traffic lane 52 of the road 50 having traffic lanes 51, 52 and 53. The lane 51 and lane 52 are divided by a lane marking line 54, and the lane 52 and lane 53 are divided by a lane marking line 55.

At the branching location 200 of the road 50, the road 60 branches from the road 50. The branched road 50 has a lane 51 and a lane 59. The lane 51 and lane 59 are divided by a lane marking line 54.

The road 60 has a lane 61 and a lane 62. The lane 61 and lane 62 are divided by a lane marking line 63.

The traffic lane 52 in which the vehicle 10 is traveling branches into a lane 59 and lane 61 at a branching location (corresponding to the branching start location) 200, and extends in the traveling direction of the vehicle 10. The lane 59 is within the road 50 and the lane 61 is within the road 60, and therefore the lane 59 and lane 61 are within different roads. The region between the end point of the lane 52 and the start point of lane 59 and lane 61 is a zone without a lane marking line.

The terrain that includes the branching location 200 is a branching terrain 201. At the branching terrain 201, the traffic lane 52 in which the vehicle 10 is traveling branches into the lane 59 and lane 61 at the branching location 200 and extends in the traveling direction of the vehicle 10, and before the branching location 200, the lane 52 is adjacent to lanes 51, 53 where the vehicle 10 can move between lanes.

In the example shown in FIG. 5, the driver of the vehicle 10 intended to proceed to the road 60 at the branching location 200, and therefore thought to move from the lane 52 to the lane 53. The vehicle 10 attempted to move from the lane 52 to the lane 53 in response to a driver request, but movement between lanes was not carried out by the vehicle control system 1 due to the presence of the vehicle 92. Lane movement information is thus generated that includes the attempt of the vehicle 10 to move from the lane 52 to the lane 53.

In the example shown in FIG. 5, the lane 59 and lane 61 were within different roads and the vehicle 10 was attempted to move from the lane 52 to the lane 53. Based on the lane movement information, the traveling lane planning device 14 selects the lane 61 located on the same side as the direction in which the vehicle 10 has attempted to move between lane 52 and lane 53, from among lane 59 and lane 61, as the lane in which to proceed at the branching location 200.

The traveling lane planning device 14 also generates a traveling lane plan indicating the scheduled traveling lane in which the vehicle 10 is to travel at the nearest driving zone, so as to include the lane 61.

The driver of the vehicle 10 had thought to proceed from the road 50 to the road 60. If the vehicle 10 had proceeded to the lane 59, the vehicle 10 would have proceeded to the road 50 where the driver had no intention to proceed. For the branching terrain 201, the traveling lane planning device 14 therefore selects lane 61 which is in line with the intention of the driver, based on the lane movement information.

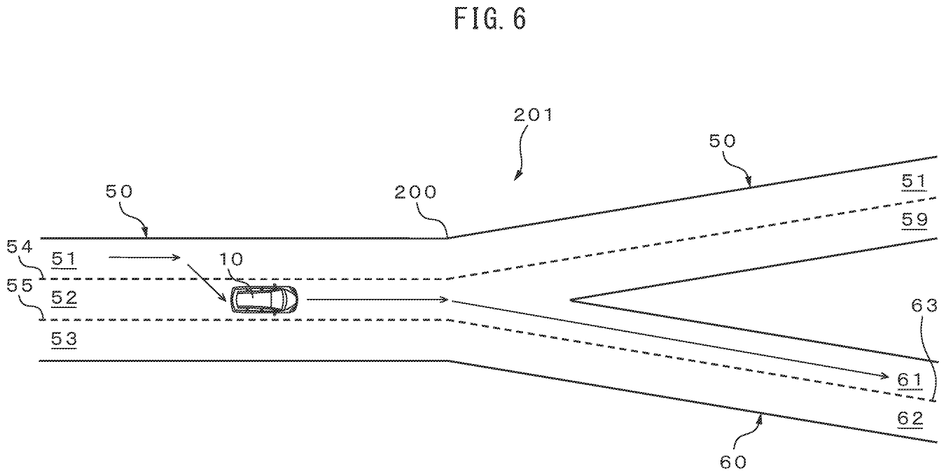

A fourth operating example of the traveling lane planning device 14 will now be further explained with reference to FIG. 6. No navigation route has been generated for the fourth operating example.

In the fourth operating example shown in FIG. 6, the vehicle 10 is traveling on a traffic lane 52 of a road 50, similar to the third operating example. At the branching location 200 of the road 50, the road 60 branches from the road 50.

In the example shown in FIG. 6, the driver of the vehicle 10 intended to proceed to the road 60 at the branching location 200, and therefore thought to move from the lane 51 to the lane 52. The vehicle control system 1 has moved the vehicle 10 from the lane 51 to the lane 52 in response to a driver request. Lane movement information is thus generated that includes the attempt of the vehicle 10 to move from the lane 51 to the lane 52.

In the example shown in FIG. 6, the traveling lane planning device 14, the lane 59 and lane 61 were within different roads and the vehicle 10 was moving from the lane 51 to the lane 52. Based on the lane movement information, the traveling lane planning device 14 selects the lane 61 located on the same side as the direction in which the vehicle 10 has attempted to move between lane 51 and lane 52, from among lane 59 and lane 61, as the lane in which to proceed at the branching location 200.

The traveling lane planning device 14 also generates a traveling lane plan indicating the scheduled traveling lane in which the vehicle 10 is to travel at the nearest driving zone, so as to include the lane 61.

The driver of the vehicle 10 had thought to proceed from the road 50 to the road 60. If the vehicle 10 had proceeded to the lane 59, the vehicle 10 would have proceeded to the road 50 where the driver had no intention to proceed. For the branching terrain 201, the traveling lane planning device 14 therefore selects lane 61 which is in line with the intention of the driver, based on the lane movement information.

With the traveling lane planning device of the embodiment described above, information for previous movement between lanes by the driver is utilized when the vehicle is in a branching terrain, and it is therefore possible to select a traffic lane that is assumed to reflect the intention of the driver.

The following explanation regards operation of the traveling lane planning unit 230 whereby a lane is selected based on a score at a branching start location.

The traveling lane on which the vehicle 10 is traveling branches into two lanes (lane 1 and lane 2) at a branching start location. Lane 1 and lane 2 are within the same road, with lane 2 as the lane on the passing lane side. The initial score for lane 1 is 100, and the initial score for lane 2 is 0.

With this traveling lane planning unit 230, the vehicle 10 has attempted to make a lane change from a traveling lane to a passing lane at a location of X km before the branching start location. Lane movement information is thus generated that includes the attempt of the vehicle 10 to move from the the traveling lane to the passing lane. The traveling lane planning unit 230 adds value Y calculated by the following formula (1) to the initial score of lane 2, determining the current score for lane 2. When the value of Y falls below 0, it is set to Y=0.

Y=(10−X)×15 (1)

With X as ≤3.33 in this example, the score for lane 2 is greater than the score for lane 1, and therefore lane 2 is selected from among the two lanes.

The vehicle 10 also attempts to make a lane change from a traveling lane to a passing lane at locations of 4 km and 6 km before the branching start location. The values of Y calculated by formula (1) are 90 and 60 for the two lane changes, with a total of 150. The value of 150 is added to the initial score for lane 2, and lane 2 is selected from among the two lanes.

Different formulas may also be used to calculate the value of Y, for when a navigation route has been set and when a navigation route has not been set. For example, formula (1) may be used to calculate Y when a navigation route has been set, and the 15 in formula (1) may be changed to 20 to calculate Y when a navigation route has not been set.

Different formulas may also be used to calculate Y when the speed of the vehicle 10 is below a reference speed and when the speed of the vehicle 10 is above the reference speed.

In step S101 above, when no adjacent lane exists adjacent to the traveling lane in which the vehicle 10 is traveling before the branching start location, it is determined that no branching terrain exists (step S101—No). In this case as well, the traveling lane planning unit 230 may select one lane from among two lanes at the branching start location, based on the scores. The initial score for lane 1 may be 100 and the initial score for lane 2 (on the passing lane side) may be 0, similar to the previous example. Different initial scores may also be used, for when a navigation route has been set and when a navigation route has not been set. When a navigation route has been set, a value of 500 may be added to the score of the road lane represented in the navigation route. A value of (−50) may also be added to the score of the lane on the passing lane side. When a navigation route has been set, the number of lane changes planned from the current location of the vehicle 10 until reaching the destination location may be calculated for each of the two lanes and a value of (−50) may be added to each of the scores of the two lanes, for each lane change.

The traveling lane planning device, computer program for traveling lane planning and traveling lane planning method of the aforementioned embodiments of the invention may also incorporate appropriate modifications that are still within the gist of the disclosure. Moreover, the technical scope of the disclosure is not limited to these embodiments, and includes the invention and its equivalents as laid out in the Claims.

1. A traveling lane planning device which comprises:
a processor configured to:
determine whether or not a branching terrain exists that has a first lane and a second lane adjacent to the first lane wherein the first lane branches into a third lane and a fourth lane at a branching start location in the traveling direction of the vehicle within a predetermined driving zone from the current location of a vehicle,
acquire lane movement information for movement between the first lane and second lane came off in the past when the branching terrain exists within the driving zone and the vehicle is located before the branching start location, and
select one lane from among the third lane and fourth lane as the lane to be taken at the branching start location based on the lane movement information and generate a traveling lane plan that indicates a scheduled traveling lane for traveling of the vehicle in the driving zone.

2. The traveling lane planning device according to claim 1, wherein the processor is further configured to select the one lane located on the opposite side from the direction in which the vehicle has attempted to move between the first lane and second lane as the lane to be taken at the branching start location, based on the lane movement information, when the first lane, the second lane, the third lane and the fourth lane are within the same road.

3. The traveling lane planning device according to claim 1, wherein the processor is further configured to select the one lane located on the same side as the direction in which the vehicle has attempted to move between the first lane and second lane as the lane to be taken at the branching start location, based on the lane movement information, when the third lane and the fourth lane are within different roads.

4. A computer-readable non-transitory storage medium that stores a computer program for traveling lane planning, which causes a processor execute a process, the process comprising:
determining whether or not a branching terrain exists that has a first lane and a second lane adjacent to the first lane wherein the first lane branches into a third lane and a fourth lane at a branching start location in the traveling direction of the vehicle within a predetermined driving zone from the current location of a vehicle;
acquiring lane movement information for movement between the first lane and second lane came off in the past when the branching terrain exists within the driving zone and the vehicle is located before the branching start location; and
selecting one lane from among the third lane and fourth lane as the lane to be taken at the branching start location based on the lane movement information and generating a traveling lane plan that indicates a scheduled traveling lane for traveling of the vehicle in the driving zone.

5. A traveling lane planning method which is carried out by a traveling lane planning device and the method comprising:
determining whether or not a branching terrain exists that has a first lane and a second lane adjacent to the first lane wherein the first lane branches into a third lane and a fourth lane at a branching start location in the traveling direction of the vehicle within a predetermined driving zone from the current location of a vehicle;
acquiring lane movement information for movement between the first lane and second lane came off in the past when the branching terrain exists within the driving zone and the vehicle is located before the branching start location; and
selecting one lane from among the third lane and fourth lane as the lane to be taken at the branching start location based on the lane movement information and generating a traveling lane plan that indicates a scheduled traveling lane for traveling of the vehicle in the driving zone.
